(19) United States
(12) Patent Application Publication
(10) Pub. No.: US 2015/0285000 A1
(43) Pub. Date: Oct. 8, 2015

(54) Apparatus for Rolling a Roman Blind

(71) Applicant: Tai-Ping LIU, TAICHUNG (TW)

(72) Inventor: Tai-Ping LIU, TAICHUNG (TW)

(21) Appl. No.: 14/243,449

(22) Filed: Apr. 2, 2014

(51) Int. Cl. E06B 9/80

(52) U.S. Cl. CPC E06B 9/80

(57) ABSTRACT

A reel-damping apparatus includes a cylinder, a leafed wheel, a plug and a moving ring. The cylinder includes an open end, a closed end and a track formed on an internal side. The leafed wheel includes a rod, a first end, a second end, at least one leaf formed on the rod, and a thread formed on the rod. The leafed wheel is inserted in the leafed wheel except the first end. The plug is fit in the cylinder through the open end and mounted on the rod so that the plug and the cylinder are rotatable relative to the leafed wheel. The moving ring including a thread engaged with the thread of the leafed wheel and at least one fin movable along the track. Damping liquid is filled in the cylinder to damp the cylinder when the cylinder is rotated relative to the leafed wheel.

### BACKGROUND OF INVENTION

1. Field of Invention

The present invention relates to a Roman blind and, more particularly, to an apparatus for rolling a Roman blind.

2. Related Prior Art

A Roman blind can be supported on a conventional rolling apparatus that includes a reel and a rope. The Roman blind includes an upper edge tied to the reel. The rope is connected to the reel. The rope is pulled to rotate the reel to reel or release the Roman blind. The reeling of the Roman blind is inconvenient.

The Roman blind can be supported on a rolling apparatus that includes a reel, a rope, a shaft and a spring. The upper edge of the Roman blind is tied to the reel. The rope is connected to the reel. The shaft is inserted in the reel. The spring is provided between the shaft and the reel. The rope is pulled to rotate the reel to release the Roman blind and at the same time load the spring. The Roman blind can be reeled by the spring automatically if so desired. The reeling of the Roman blind is however fast and hence dangerous.

Therefore, the present invention is intended to obviate or at least alleviate the problems encountered in prior art.

### SUMMARY OF INVENTION

It is the primary objective of the present invention to provide a reel-damping apparatus.

To achieve the foregoing objective, the reel-damping apparatus includes a cylinder, a leafed wheel, a plug and a moving ring. The cylinder includes an open end, a closed end and a track formed on an internal side. The leafed wheel includes a rod, a first end, a second end, at least one leaf formed on the rod, and a thread formed on the rod. The leafed wheel is inserted in the leafed wheel except the first end. The plug is fit in the cylinder through the open end and mounted on the rod so that the plug and the cylinder are rotatable relative to the leafed wheel. The moving ring including a thread engaged with the thread of the leafed wheel and at least one fin movable along the track. The moving ring is movable along a portion of the rod on which the thread is formed when the cylinder and the moving ring are rotated relative to the leafed wheel. The rotation of the cylinder relative to the leafed wheel is stopped when the moving ring is stopped by the closed end of the cylinder. The number of rounds of the rotation of the cylinder relative to the leafed wheel is adjustable by adjusting the position of the moving ring on the rod. Damping liquid is filled in the cylinder to damp the cylinder when the cylinder is rotated relative to the leafed wheel.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a reel-damping apparatus according to the first embodiment of the present invention;

FIG. 2 is a cross-sectional view of the reel-damping apparatus shown in FIG. 1;

FIG. 3 is another cross-sectional view of the reel-damping apparatus illustrated in FIG. 1;

FIG. 4 is another cross-sectional view of the reel-damping apparatus illustrated in FIG. 1;

FIG. 5 is a perspective view of a reel and the reel-damping apparatus shown in FIG. 1;

FIG. 6 is a partial, cross-sectional view of a Roman blind-rolling apparatus using the reel and the reel-damping apparatus shown in FIG. 5;

FIG. 7 is another partial, cross-sectional view of the Roman blind-rolling apparatus shown in FIG. 6;

FIG. 8 is an exploded view of a reel-damping apparatus according to the second embodiment of the present invention; and

FIG. 9 is a cross-sectional view of the reel-damping apparatus shown in FIG. 8.

### DETAILED DESCRIPTION OF EMBODIMENTS

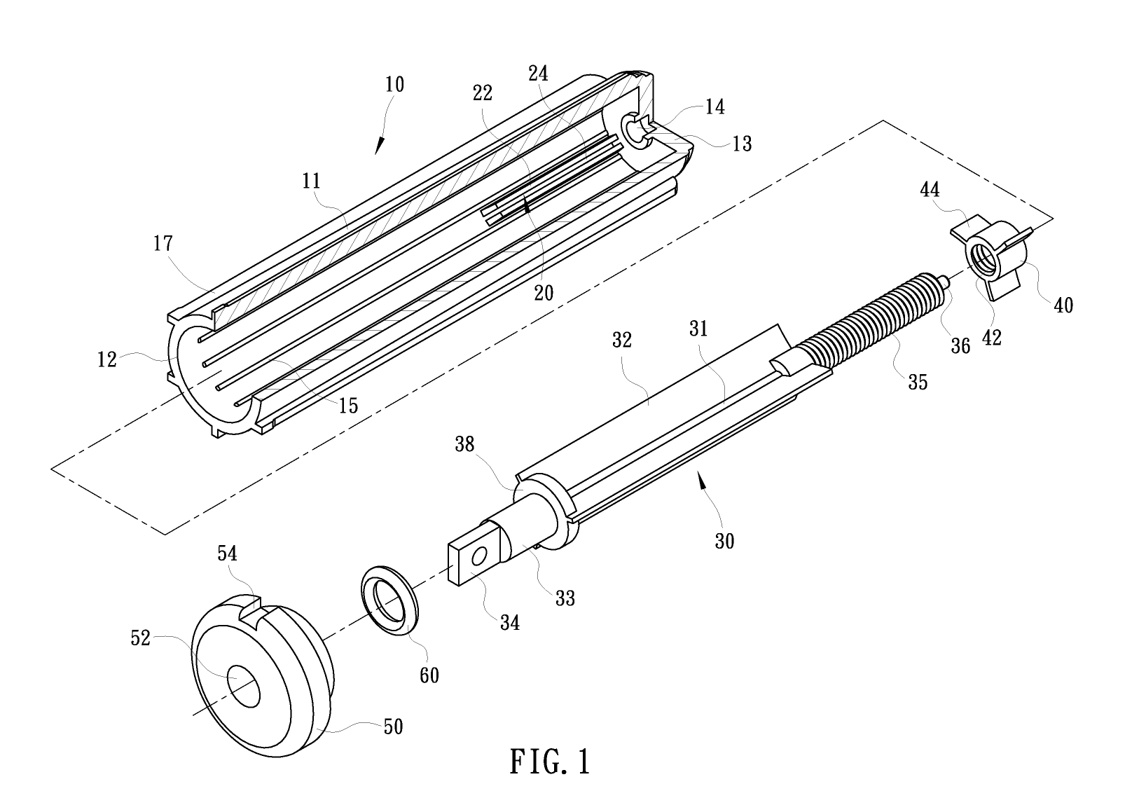

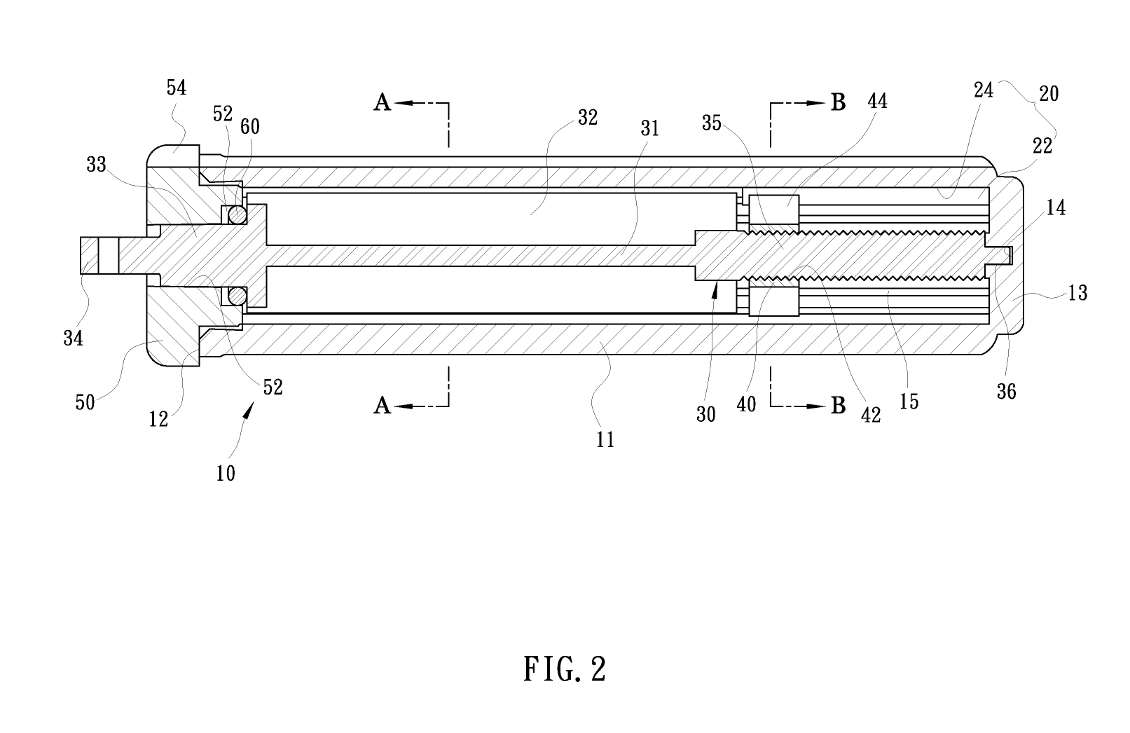

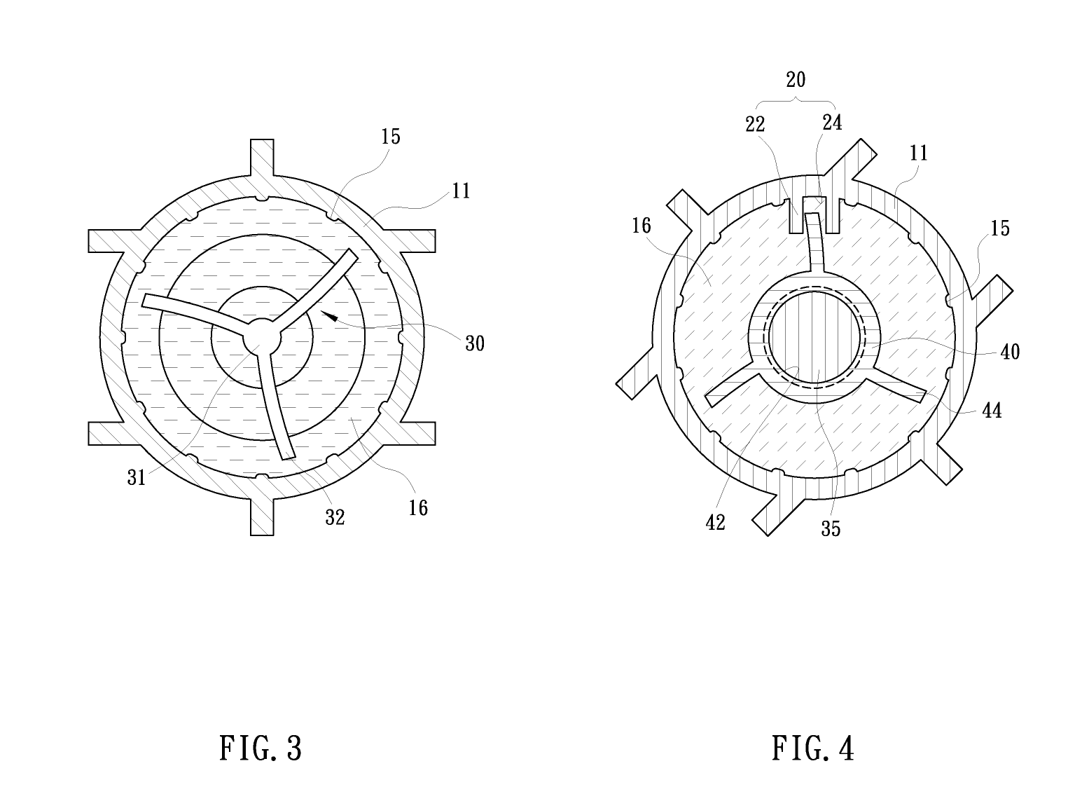

Referring to FIGS. 1 to 4, a reel-damping apparatus 10 includes a cylinder 11, a leafed wheel 30, a stroke-adjusting unit and a plug 50 in accordance with a first embodiment of the present invention. The stroke-adjusting unit includes a track 20 and a moving ring 40.

The cylinder 11 is formed with an open end 12 and a closed end 13. A bore 14 is made in the closed end 13. The cylinder 11 includes ribs 15 longitudinally extending on an internal side and ribs 17 longitudinally extending on an external side.

The leafed wheel 30 includes leaves 32 longitudinally extending on a rod 31. The rod 31 includes a flat end 34, an axle 33 near the flat end 34, a disc 38 near the axle 33, a circular end 36 opposite to the flat end 34, and a thread 35 near the circular end 36.

The track 20 includes two strips 22 longitudinally extending on the internal side of the cylinder 11. A groove 24 is defined by and between the strips 22.

The moving ring 40 includes a thread 42 extending on an internal side and preferably three fins 44 extending on an external side. The thread 42 is configured corresponding to the thread 35.

The plug 50 includes an aperture 52 centrally made therein. The aperture 52 includes a large section and a small section. The plug 50 includes a stepped configuration that includes a large section and a small section. A cutout 54 is made in the large section of the plug 50.

The thread 42 is engaged with the thread 35 to mount the moving ring 40 on the rod 31. The leafed wheel 30 and the moving ring 40 are inserted in the cylinder 11. The circular end 36 of the rod 31 is inserted in the bore 14. One of the fins 44 is inserted in the groove 24. A sealing ring 60 is placed on the axle 33. The small section of the plug 50 is fit in the cylinder 11 after the cylinder 11 is filled with damping liquid 16. The large section of the plug 50 is placed out of the cylinder 11. The sealing ring 60 is inserted in the large section of the aperture 52. The sealing ring 60 is compressed between the small section of the plug 50 and the axle 33 and placed against the disc 38 to avoid any leak of the damping liquid 16 from the cylinder 11. The axle 33 is inserted in the small section of the aperture 52 so that the plug 50 is rotationally mounted on the axle 33 and that the cylinder 11 is rotationally mounted on the leafed wheel 30.

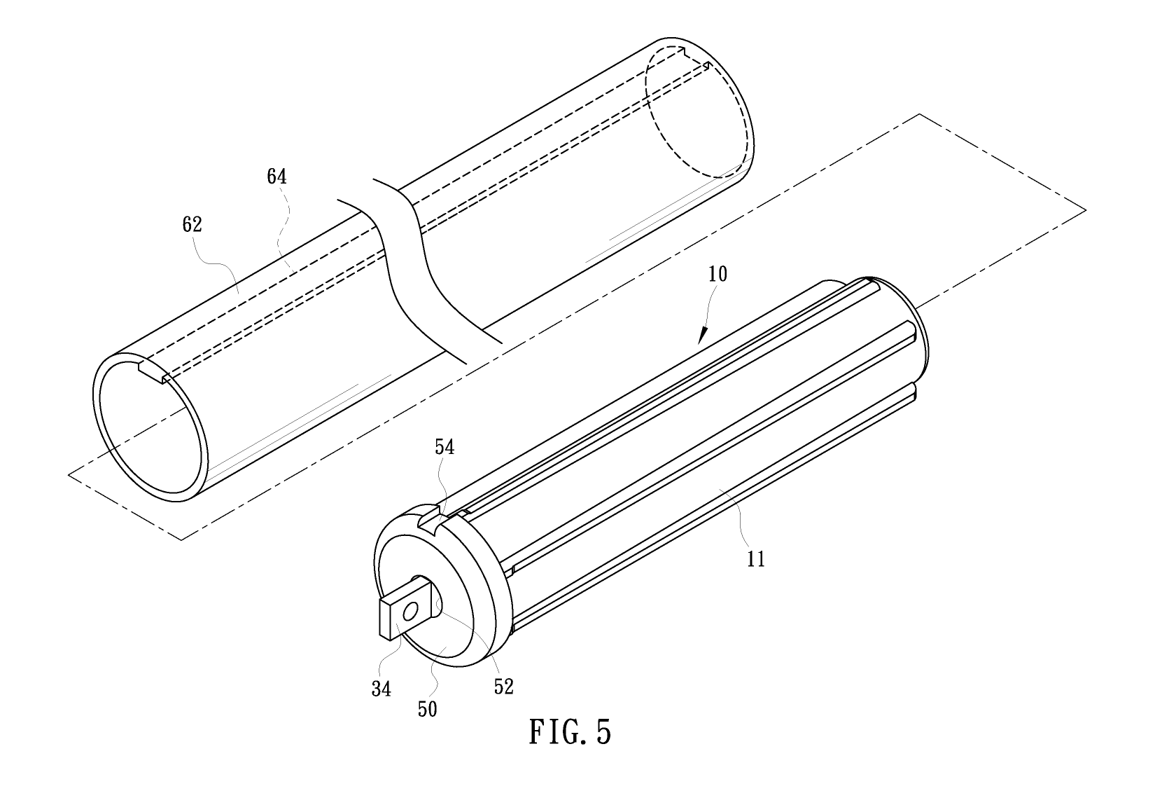

Referring to FIG. 5, the reel-damping apparatus 10 is used with a reel 62. The reel 62 is a tubular element with a rib 64 longitudinally extending on an internal side.

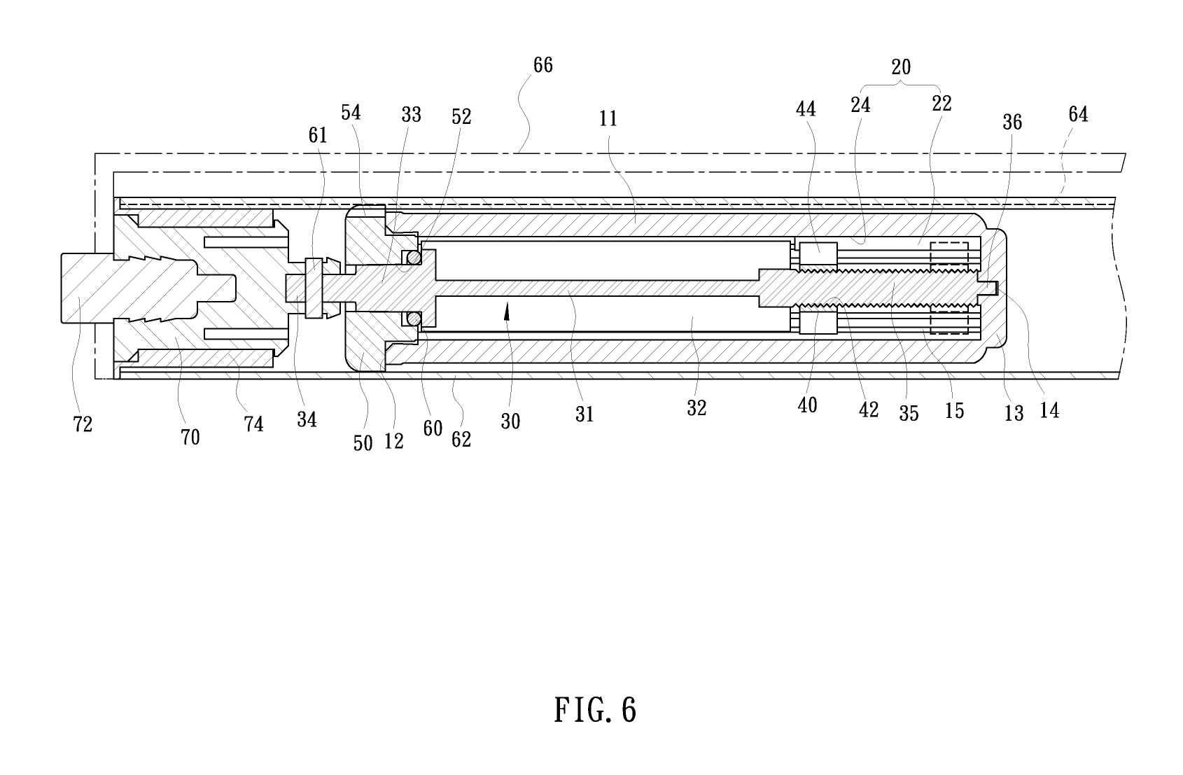

Referring to FIG. 6, the reel-damping apparatus 10 and the reel 62 are used with a frame 66 and an axle 70. A tubular lining 74 is rotationally placed on the axle 70. The flat end 34 of the rod 31 is inserted in a tubular end of an axle 70. A pin 61 is transversely inserted in the flat end 34 of the rod 31 and the tubular end of the axle 70 so that the leafed wheel 30 is firmly connected to the axle 70. The reel-damping apparatus 10 is inserted in the reel 62. The cutout 54 receives the rib 64 so that the reel-damping apparatus 10 is rotatable with the reel 62. The tubular lining 74 is fit in a left end of the reel 62 so that the tubular lining 74 is rotatable with the reel 62. A key 72 is inserted in a left end of the frame 66 and the axle 70 so that the axle 70 is firmly connected to the frame 66. The frame 66 is attached to a wall above a window for example.

In use, a Roman blind is connected to the reel 62. The Roman blind can be unwound from or wound onto the reel 62. In both scenarios, the reel 62, the plug 50, the cylinder 11 and the moving ring 40 are rotated while the key 72, the axle 70 and the leafed wheel 30 are held still. The rotation of the cylinder 11 relative to the leafed wheel 30 is damped by the damping liquid 16. Hence, the unwinding and winding is damped.

The moving ring 40 is not only rotated around the rod 31 but also longitudinally moved along the rod 31 because the thread 42 is engaged with the thread 35. The unwinding of the Roman blind is stopped when the moving ring 40 is stopped by the closed end 13 of the cylinder 11. The stroke of the unwinding of the Roman blind is adjustable by the stroke-adjusting unit. To this end, the position of the moving ring 40 on the thread 35 is adjusted when the Roman blind is completely wound on the reel 62. The closer the moving ring 40 is to the closed end of the cylinder 11 when the Roman blind is completely wound on the reel 62, the shorter the stroke of the unwinding of the Roman blind is.

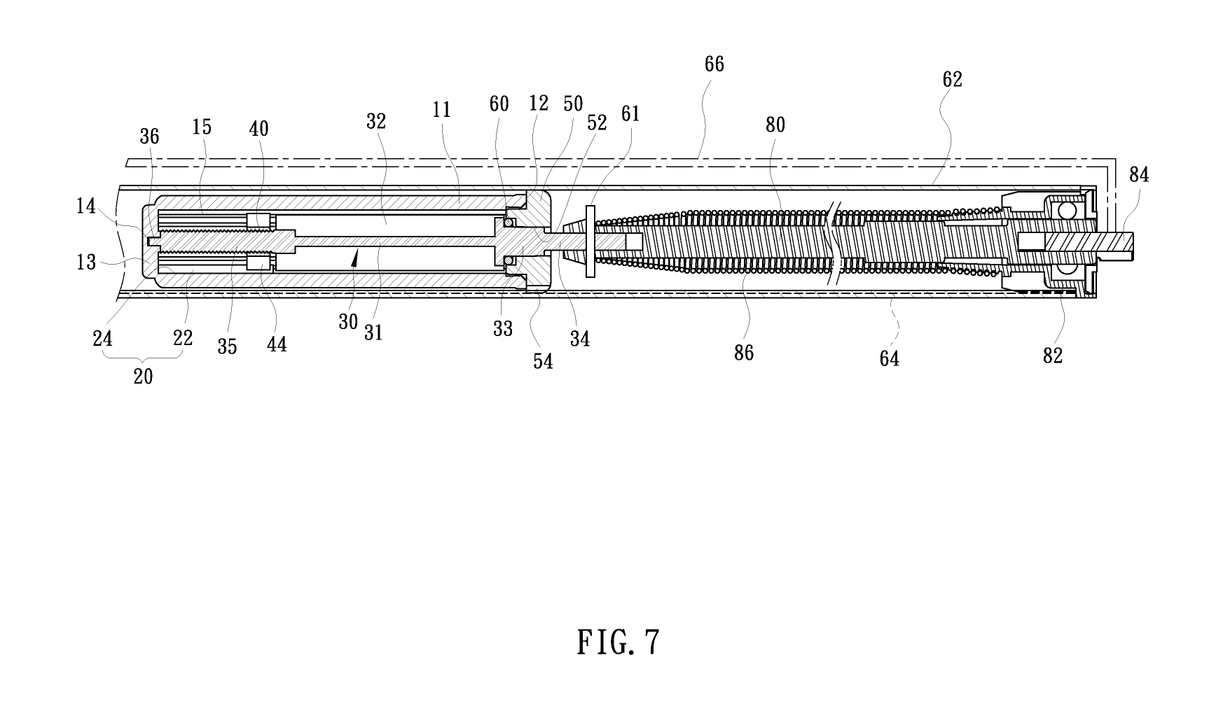

Referring to FIG. 7, the reel-damping apparatus 10 is located near a right end of the frame 66 instead of the left end. The flat end 34 of the rod 31 is inserted in a tubular end of an axle 80 connected to the right end of the frame 66 by a key 84. A spring 86 includes an end connected to the axle 80 and another end connected to a tubular lining 82 rotationally supported on the axle 80. The spring 86 is loaded when the Roman blind is unwound from the reel 62 by a force. The Roman blind is wound on the reel 62 by the spring 86 when the force is stopped. The winding of the reel 62 is damped by the reel-damping apparatus 10 so that the winding of the reel 62 is kept at a proper and safe range.

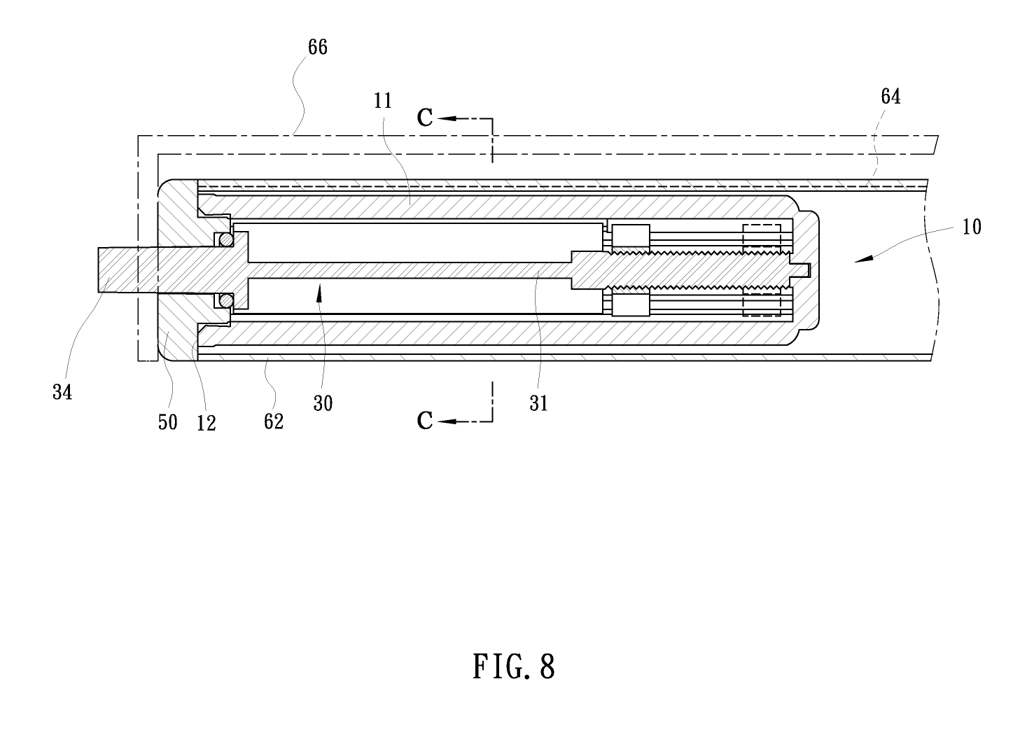

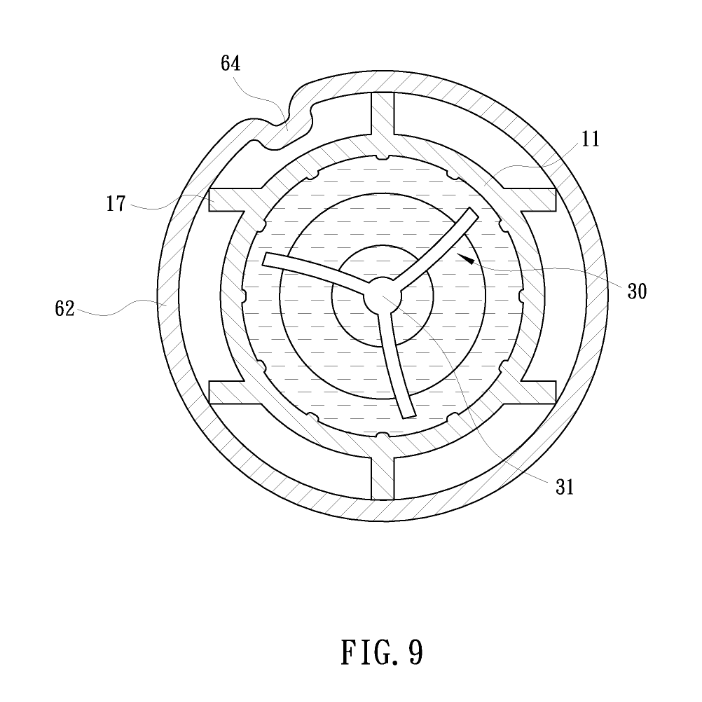

Referring to FIGS. 8 and 9, there is a reel-damping apparatus 10 in accordance with a second embodiment of the present invention. The second embodiment is identical to the first embodiment except several things. Firstly, the plug 50 does not include the cutout 54. Secondly, one of the ribs 17 is pressed against a rib 64 formed on an internal side of the reel 62 so that the cylinder 11 is rotatable with the reel 62. Thirdly, the flat end 34 of the rod 31 is inserted in a slot (not numbered) made in the left end of the frame 66.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A reel-damping apparatus including:
a cylinder including an open end , a closed end and a track formed on an internal side;
a leafed wheel including a rod, a first end, a second end, at least one leaf formed on the rod, and a thread formed on the rod, wherein the leafed wheel is inserted in the leafed wheel except the first end;
a plug fit in the cylinder through the open end and mounted on the rod so that the plug and the cylinder are rotatable relative to the leafed wheel;
a moving ring including a thread engaged with the thread of the leafed wheel and at least one fin movable along the track, wherein the moving ring is movable along a portion of the rod on which the thread is formed when the cylinder and the moving ring are rotated relative to the leafed wheel, wherein the rotation of the cylinder relative to the leafed wheel is stopped when the moving ring is stopped by the closed end of the cylinder, wherein the number of rounds of the rotation of the cylinder relative to the leafed wheel is adjustable by adjusting the position of the moving ring on the rod; and damping liquid filled in the cylinder to damp the cylinder when the cylinder is rotated relative to the leafed wheel.

2. The reel-damping apparatus according to claim 1, wherein the rod includes a circular end placed against the closed end of the cylinder.

3. The reel-damping apparatus according to claim 2, wherein the closed end of the cylinder includes a bore for receiving the circular end of the rod.

4. The reel-damping apparatus according to claim 1, wherein the rod includes an axle extending through the plug.

5. The reel-damping apparatus according to claim 4, wherein the rod includes a flat end axially extending from the axle, wherein the flat end of the rod is placed out of the cylinder and can be connected to a frame.

6. The reel-damping apparatus according to claim 1, wherein the cylinder includes, on an internal side, at least one rib for stirring the damping liquid.

7. The reel-damping apparatus according to claim 1, wherein the track includes a groove for movably receiving the fin of the moving ring.

8. The reel-damping apparatus according to claim 1, wherein one of the cylinder and the plug includes a cutout for receiving a rib formed on an internal side of a reel.

9. The reel-damping apparatus according to claim 1, wherein one of the cylinder and the plug includes a rib for abutment against a rib formed on an internal side of a reel.
